(19) United States
(12) Patent Application Publication
(10) Pub. No.: US 2014/0200063 A1
(43) Pub. Date: Jul. 17, 2014

(54) SYSTEM AND METHOD FOR AN INTERNET BASED SWEEPSTAKES

(71) Applicant: Pieter C. Wiest, Detroit, MI (US)

(72) Inventor: Pieter C. Wiest, Detroit, MI (US)

(21) Appl. No.: 13/744,348

(22) Filed: Jan. 17, 2013

(51) Int. Cl. G07F 17/32

(52) U.S. Cl. CPC G07F 17/329; G07F 17/3272
USPC 463/17

(57) ABSTRACT

An internet-facilitated contest—a Sweepstakes—played by participants, randomly selected as eligible, on whose computers the application resides. The invention involves such a participant's attempts to electronically connect with another such randomly-selected eligible participant. Prizes are awarded to those participants who successfully make such a connection within certain time constraints. The invention contemplates a computer program being readable by the computer for executing method of the invention. The invention further contemplates a machine-readable memory tangibly embodying a program of instructions executable by the machine for executing the method of this invention.

### FIELD OF THE INVENTION

The present invention relates to a system and method for conducting an internet facilitated Sweepstakes entered into by selected participants. The manner of this participant selection process, the subsequent actions of these participants, and the manner in which the Sweepstakes winners are determined provide a novel method for the entertainment of participants. This system and method, taken together with the potential for these participants to experience material reward, possibly including monetary reward, creates a highly unique contest.

### BACKGROUND OF THE INVENTION

Sweepstakes are commonly associated with marketing promotions targeted toward both generating enthusiasm and providing incentive reactions among customers by inviting consumers to submit free entries into drawings of chance. This type of sweepstakes is often run by a sponsoring company in order to generate increased sales for said sponsor. There is no monetary cost associated with entry in this type of sweepstakes. Further, some sweepstakes may require entrants to submit personal information, used in compiling mailing lists, which lists may subject the entrant to spam, junk email, telemarketing calls, and other such unwanted outcomes. Also, submission of this personal information may be followed by lengthy waiting periods that precede the sweepstakes' drawing. The odds of winning such a sweepstakes is often quite low, also. Further, there is little or no sense of an active, ongoing game, contest, or competition. In all, the above-described process is distinctly lacking in excitement.

The present invention is different in many regards from other sweepstakes presently available on the internet. In one aspect of this invention, participants are selected by the Sweepstakes' server. Secondly, participants take an active part in the winning of the Sweepstakes by using their electronic devices. The Sweepstakes of this invention also provides elements of fun, anticipation, and surprise for the participants because they are required to play by providing input from their electronic devices to the Sweepstakes' server in a given amount of time. And winning is a result of a random assignment process that is closely tied to the electronic input from participants' electronic devices. Winners are notified instantly in case of a win and winnings may frequently, if not always, be in cold, hard cash.

### SUMMARY OF THE INVENTION

The system of this invention comprises a computer or a similarly functioning electronic device, and a server, also termed herein “Sweepstakes' server,” on which an algorithm resides. A digital signal generated by this computer's algorithm is sent to a further aspect of the invention's system, the internet, or to another similarly functioning electronic network.

Thereafter, in further accordance with the above algorithm, an additional digital signal is sent, this time from the internet to each of the eligible computers selected for participation in the Sweepstakes. These computers have been designated as eligible by a function of the above algorithm that utilizes random selection capability. They have also been found eligible in that the algorithm has determined that these computers are open to the appropriate internet site on which the Sweepstakes constituting this invention is viewed.

The above mentioned signal, that between the internet and the potential participants' computers or any similarly functioning device, notifies these eligible computers' users that they have been selected for Sweepstakes play, should they desire to participate. The computers of these potential participants also constitute further aspects of the system of this invention.

The method of this invention involves the participation of those selected individuals mentioned above. At a time when these participants' computers have an active electronic interface with the internet, and are open to the appropriate internet site on which to view information from the Sweepstakes' server, their eligibility for possible play in the sweepstakes will be signaled to them by an icon or another signal on their computers' displays. They will also be notified that the Sweepstakes, and their participation in it are time-limited, that is, play will last for only a specifically stated length of time.

Each of these randomly selected eligible participants may ignore the opportunity to take part in the contest, or alternatively, to participate. Those choosing to participate will be instructed to attempt to electronically connect, each with any other individual within this group of randomly selected eligible participants.

That is, they will each be instructed to attempt by means of repeated pressings of their return keys, or by some other designated means, to electronically connect with another eligible participant. An examination of merely one such signal sent, though presumably many would be sent from each participant's computer, would show the device's user utilizing its return key or other designated means to generate a signal that will then be communicated to the internet, which in turn will communicate the signal to the server on which the Sweepstakes' algorithm resides. This server will have the means to identify each signal as to its computer or device of origin.

When this above signal reaches the server, it will be randomly assigned by a function of the algorithm to a computer within the total universe of computers on which the Sweepstakes appear. This body of devices is also termed the “Sweepstakes' pool”.

Should such an assignment bring about, by means that are an aspect of both the system and the method of this invention, the much sought-for connection between two eligible Sweepstakes participants, the two participants are winners, and immediately announced as such.

### BRIEF DESCRIPTION OF THE DRAWINGS

An embodiment of the invention will now be described with reference to the following drawings so that it may be more fully understood. It is stressed that the particulars shown are by way of example and for purposes of illustrative discussion of the preferred embodiment of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention. The description, taken with the drawings, makes apparent to those skilled in the art how the invention may be embodied in practice.

The description herein makes reference to the accompanying drawings wherein like reference numerals refer to like aspects of the invention throughout the several drawings.

FIG. 1 illustrates an in-use example of the system of the present invention, a Sweepstakes.

FIG. 2 is a flowchart schematically representing the system and method of the present invention, a Sweepstakes.

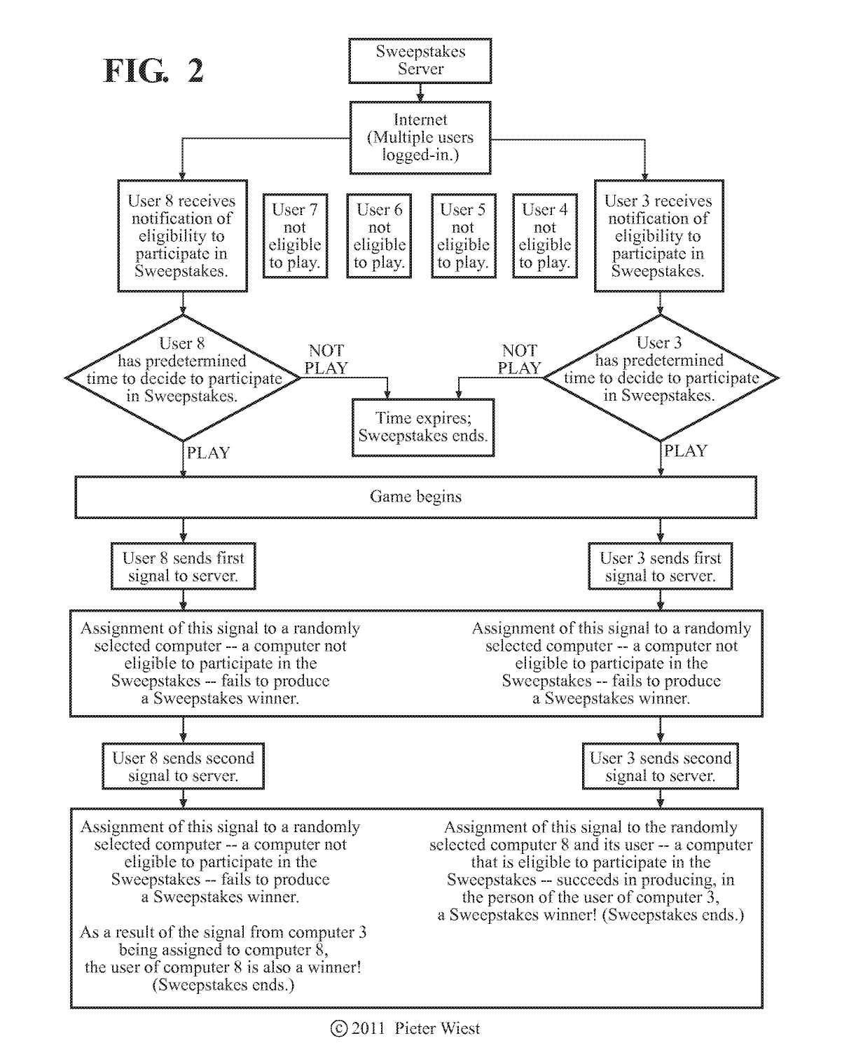

### DEFINITIONS

“Sweepstakes” as used in this invention refers to an internet based contest which resides on a web site. Participants in this Sweepstakes have undertaken a user agreement with this web site.

“Sweepstakes server” or “server” refers to a computer hardware system dedicated to run the internet based Sweepstakes. This server provides means of a database server, file server, and web server as needed to run the Sweepstakes. The Sweepstakes program, the algorithm, resides on the server. This server may or may not be a computer.

“Sweepstakes pool” refers to the above-mentioned web site's users who have undertaken a user agreement with the Sweepstakes web site regarding the Sweepstakes.

“Algorithm” refers to a program or application necessary for functioning of the online Sweepstakes. The algorithm runs on the Sweepstakes' server. In certain preferred embodiments of the invention, an aspect of the algorithm is a random-function generator.

“Eligible participant” is a user who has been randomly selected by an aspect of the algorithm for participation in the online Sweepstakes. The algorithm has also determined that electronic devices of these users are open to the appropriate internet site on which the Sweepstakes constituting this invention is viewed, and that said users have also not opted out of participation in the online Sweepstakes.

“Electronic device” refers to a personal computer (computer), laptop computer, notebook computer, tablet computer, smart phone, game console, internet-connected television or other device useful for communication with the Sweepstakes' server.

### DETAILED DESCRIPTION OF THE INVENTION

A portion of the disclosure of this patent document contains material that is subject to copyright protection. The copyright owner has no objection to facsimile reproduction, by anyone, of the patent document or the patent disclosure as it appears in the Patent and Trademark Office patent file or records, but otherwise reserves all copyright rights whatsoever.

The present invention's numbered features include suitably programmed computers and similar devices that, together, comprise the system. This system, when used in a specific manner, constitutes a method capable of producing a novel outcome. This system allows specially selected users of some of the computers and similarly functioning devices comprising the system to search for other such specially selected users in order to make an electronic connection, one with the other, by which means they are determined to be winners of the application's Sweepstakes.

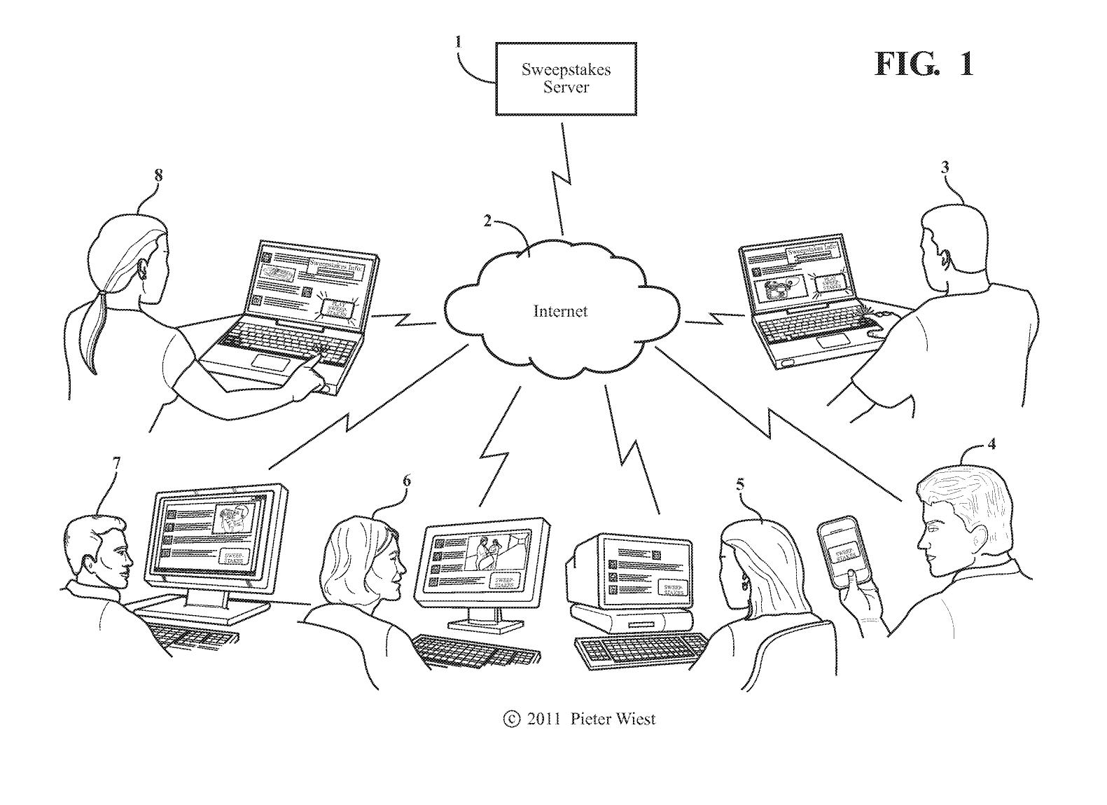

FIG. 1 shows a preferred embodiment of the Sweepstakes' server 1, on which a digital algorithm runs which algorithm directs all aspects of the Sweepstakes. In a further preferred embodiment the Sweepstakes' server can be a computer capable of running the algorithm. This server communicates with the internet 2. A computer 3 is also shown. As well, a computer 8 is shown. Additionally, four more computers 4, 5, 6, 7 are shown.

The digital algorithm necessary for the functioning of this application, a

Sweepstakes, runs on the Sweepstakes' server 1, which server will electronically signal, by means of the internet 2 that the computer 3 (and its user) has been randomly selected as an eligible participant in the Sweepstakes.

The server 1 communicates this eligibility by means of an electronic activation of the Sweepstakes' icon, as well as by the activation of any necessary information screens relative to the Sweepstakes, on computer 3. In certain preferred embodiments, other means in addition to the activation of the Sweepstakes' icon are utilized to notify the eligible participant.

In a preferred embodiment of this invention, the digital algorithm also selects computer 8 (and its user) as an eligible participant in the Sweepstakes. A notification of this eligibility is also transmitted to computer 8 and its user. In this preferred embodiment, computer 3 and computer 8 represent the entire number of computers randomly selected as eligible for participation in the Sweepstakes. The total number of such computers selected, in a real-world setting, is a function of the Sweepstakes' algorithm. This number always consists of at least two such eligible, randomly selected and open to the Sweepstakes' site, computers.

The computers 4, 5, 6, 7 not selected as eligible participants in the Sweepstakes, receive no notification regarding the Sweepstakes; the Sweepstakes' icon on their computers is not activated. These four individual computers represent the entire number of remaining computers—those ineligible—on which the application resides. The number of such computers may total many hundreds, or thousands, or even millions.

In a preferred embodiment of this invention, there are at least two functions performed by the algorithm of this Sweepstakes that rely on the algorithm's ability to affect random choices. One such function is the algorithm's choosing of those computers that, from within the entire universe of computers on which the Sweepstakes resides, are selected as eligible for participation in the Sweepstakes. Another such function is the choosing of which individual's computer, also from within the entire universe of computers on which the Sweepstakes resides, is to be the destination-computer to which the signal sent from an eligible Sweepstakes' participant's computer is assigned. The universe of computers spoken of above consists of all those computers, the Sweepstakes' pool, on which the Sweepstakes resides. In FIG. 1, this entire number of devices is schematically represented by computers 3, 4, 5, 6, 7, 8.

When the user of computer 3 elects to begin play in the Sweepstakes, by the first depression of his computer's return key in a preferred embodiment of this invention, a signal is sent from his computer 3, by way of the internet 2, to the server 1 on which the Sweepstakes' algorithm resides. In the instance presently cited, this algorithm determines that this signal has failed to connect electronically, when assigned to a randomly selected destination-computer, to one of the other computers that has been randomly selected as eligible for participation in the Sweepstakes at this time. The user of computer 3 notes that no indication of his winning, by his above attempt, is forthcoming on his device's display.

All signals dispatched from the various participants' computers, which reach server 1, by means of the internet 2, enter a queue, thereby establishing a queue-order that results from the real-time of their individual arrival at server 1. This queue-order is ultimately relied upon by server 1, on which the algorithm resides, to determine priority of the electronic responses—signals—generated by the eligible participants in the Sweepstakes. By this means, the winners of the Sweepstakes are always limited to a pairing, or pairings, of one eligible computer and its user and one other eligible computer and its user. Ties are thus avoided.

Next, the user of computer 8, also electing to play in the Sweepstakes, sends a signal from her computer 8, by depressing her computer's return key, by way of the internet 2, to the server 1 on which the system's algorithm resides. This Sweepstakes participant has also failed, as a result of the ineligibility of the randomly selected destination computer to which her signal has been assigned, to connect to a computer presently selected as eligible. Thus the user of computer 8 notes that she also has not won by this attempt.

The Sweepstakes' algorithm prevents assignment of a signal from a computer to that same computer from which the signal in question emanated.

The user of computer 8, depressing her computer's return key for a second time, again fails to connect to one of the randomly-selected eligible computers. Thus the user of computer 8 notes that she has again not won by her attempt.

The user of computer 3, now continuing his play, by the second depression of his computer's return key again sends a signal from his computer, by way of the internet 2, to the server 1 on which the system's algorithm resides.

In this instance, the algorithm determines that this signal has successfully connected electronically, when assigned to a randomly selected destination-computer, to one of the other computers, computer 8, which has been selected as eligible for Sweepstakes participation. The user of computer 3 notes his winning, by this latest attempt, as the result of an announcement that will appear on his computer's display. In the same manner, the user of computer 8 notes that she has also won. At this time, the Sweepstakes ends.

In a further preferred embodiment of this invention, an eligible participant, the participant's device being randomly selected by the Sweepstakes' server, and open to the appropriate site to view information from the Sweepstakes' server, need not be actively participating in the Sweepstakes in order to be a winner in the Sweepstakes. Being only randomly selected for participation, and open to the above-said site, is sufficient to win, in that another computer user, also selected as eligible and site-appropriately open, may create an electronic signal that is assigned to such a non-active participant. This sequence of events produces a Sweepstakes win for each party.

A preferred embodiment of this invention is described below wherein this invention is utilized by a computer user on whose computer the Sweepstakes' application resides.

The computer user connects to the internet, and then to a social network site, called “Be THERE!”. The site “BeTHERE!” has chosen to host the Sweepstakes in this example. The icon for this application, the Sweepstakes, appears on the “BeTHERE!” homepage and on all pages of this site. Also, one's “BeTHERE!” user agreement explicitly allows one to fully participate in the Sweepstakes, when selected, and to do so free of charge. Again, the application is proposed by the inventor to be available and free to all “BeTHERE!” members. An opt-out clause is also available that would allow a “BeTHERE!” user to decline having the Sweepstakes as part of his “BeTHERE!” experience.

As the “BeTHERE!” user goes about his usual activities on the site, for instance, viewing his email, he notes that the Sweepstakes' icon on his screen has become active, as an example, by blinking on and off. The user knows this signal from the application's icon indicates his fortunate selection for participation in the Sweepstakes. An information screen appears to tell him of his selection, and of any other matters relevant to his participation in the Sweepstakes. These matters include noting that all of the member's presently open screens, settings, and tabs, etc., as well as all his “BeTHERE!” screens, are saved; it also tells him how the contest, the Sweepstakes, is played; it further tells him how long he may take in deciding whether to participate or not; it also tells him how to proceed to play should he elect to; it also tells him how long he has, from the instant he begins, until his time as an active contest participant expires.

As he has heard, seen, and read about the Sweepstakes and its many well-publicized winners, many of whom have won significant prizes, the computer user is anxious to participate in the Sweepstakes. The computer user rapidly and repeatedly depresses his return key after he is informed by the “BeTHERE!” server that he may begin. In a preferred embodiment, this is the manner described on the site's information screen, by which one participates in the Sweepstakes.

Each depression of the return key by the computer user causes a signal to be sent to the “BeTHERE!” server. Each signal upon reaching the Sweepstakes server, by means of the internet, is randomly assigned to another BeTHERE! user on whose computer the Sweepstakes' application also appears. This random assignment is made to any individual computer from among the very large number of computers on which the application runs. That number represents the “BeTHERE!” universe; that is, every “BeTHERE!” member's computer, except, of course, the computers of any users that have opted out.

In yet another preferred embodiment of this invention, during an individual's participation in the Sweepstakes, the number of other eligible participants, which number has been randomly selected by the algorithm, with whom he can attempt to establish an electronic connection is announced on the computer's display. Also, other facts about past, present, and future iterations of the Sweepstakes are available for viewing as well. These include facts about players—even present players—along with stories about past winners, stories about special upcoming Sweepstakes, and notifications about especially attractive upcoming prizes.

If the assignment of the first computer user's signals, as they come in to the Sweepstakes' server, fails to connect these signals to a computer that is, at the present instant of each such assignment, also eligible to participate in the sweepstakes, he does not succeed in winning the Sweepstakes.

However, at that instant when a signal from the first computer-user is connected, by means of the Sweepstakes' algorithm's random-selection assignment of his computer's signal to another such eligible computer somewhere in the world, the computer user of the present example is announced with all appropriate fanfare as a winner.

In fact at such a time, matched by random-assignment as outlined above, he and the other participant are both declared winners. Also at this time in a preferred embodiment, the Sweepstakes ends.

It should be understood that while the two participants touched upon in the preferred example described above are both trying to make a winning connection, perhaps so too are many others. Such a situation might be frequently encountered in a setting such as “BeTHERE!”, a setting we may imagine to contain millions of users' computers, nearly all of which may run the application. In such a setting, more than just the initial two winners may be successfully matched to eligible Sweepstakes' participants, thereby bringing about more winners then just the initial two contestants. How many possible pairs of winners are to be declared in each Sweepstakes is a matter undertaken by the Sweepstakes' algorithm and its administrators.

In a preferred embodiment, the Sweepstakes does not end when the first two winners are announced. The Sweepstakes is continued until a maximum number of users determined by the Sweepstakes' algorithm and its administrators are reached.

The internet is awash with sweepstakes. The present inventor therefore wishes to make clear the very different nature of the Sweepstakes of this invention, when compared to those sweepstakes that are encountered so frequently on the internet.

As to this latter type of sweepstakes, those seen in great numbers on the internet, you can enter any time you please. Anyone else can as well enter these types of sweepstakes. And, most of the time, playing consists of you simply entering your often not inconsiderable personal information and clicking “submit.” Next you wait, for varying lengths of time, for the sweepstakes' drawing to occur. If you win, the winnings, most often, are in the form of merchandise. Sometimes winnings are in the form of discounts on specified products.

This process of seeking a non-cash prize from a provider intent on aggregating your personal information, at the very least, lacks excitement. And again, anyone can play. And playing, that is the submission of your personal information, with no further participatory activity on your part, followed by waiting while your entry is chosen or not chosen, is inherently passive. And the prize, should there be one, can be distinctly underwhelming.

The present invention, also an online Sweepstakes, is entirely different in many regards. In one aspect of this invention, participants are selected by the Sweepstakes' server. And being thus chosen comes as a bolt from the blue. And while it may always be pleasantly awaited, such anticipation of your selection conveys no certainty of its eventual arrival. Therefore, if you are selected, it is exciting. Everyone in the aforementioned “BeTHERE!” universe is available to be selected in this earlier described random selection process undertaken by an aspect of the Sweepstake's algorithm.

Next, you play by repeatedly depressing a key on your keyboard. The faster you do so, the greater the number of your attempts to win. And you do so against the clock, so to speak. There is always a time limit on your participation. This constraint can add a note of tension, and even more excitement. Then, you win as a result of a random assignment process that is closely tied to your key-depressing activity. Or, by the same means, you do not win.

In the event of your winning, you are notified instantly. And winnings may frequently, if not always, be in cold, hard cash. Win or lose, this Sweepstakes is always exciting. And it's always free to the player, the site member.

Furthermore, an aspect of the application may cause a running account of a participant's play to appear on his Sweepstakes' information screen. This account may list the first name or avatar of each destination-computer's user and the city and country in which each of these computers, to which the participant's signals are being assigned, resides. And this will be done in what amounts to near real-time. Perhaps as well, the participant's stroke-per-second count will be shown to him. Who wouldn't want to play, especially when well-publicized recent, even daily, winnings have been widely seen and noted around the internet?

As noted, in addition to the possible use of his return key, the invention can have any number of different means by which the participant sends his repeated signals during his allotted time: he may be instructed to use another key, or more than one key may be involved, and these procedures may change during the time of his participation. The invention can also include a feature wherein a so-called “power boost” is granted to the participant which “power boost” allows the participant, while merely holding down the designated key or keys, to send a stream of discreet signals that number more than could be sent by his repeated strokes of the designated key or keys.

The earlier-discussed algorithm, which resides on the computer or server described, will have as an essential aspect the necessary programming to run all the desired functions of the application, the Sweepstakes. Some of these functions may be: determining the total number of such Sweepstakes to be held in a given time period, i.e. how many per day; how many per week, etc.; determining the number of contestants eligible in each contest; determining the specific time-limit of each contest participant's eligibility; determining the value and nature of the individual prizes.

All functions of the application's program, said to be random, are so, random, through the use of random-function producing technology well understood by those familiar with the art. These randomly generated functions are utilized in the present invention. A discussion of some aspects of the technology available for use is given at Random.org (http://www.random.org/); the entire disclosure of this discussion is included herein by reference.

As noted, by the use of its capability to produce random functions the algorithm selects those computers, from all of the computers on which the application resides, deemed as eligible participants in the Sweepstakes. Random outcomes are also achieved by the algorithm in the selection of designated computers to which incoming signals arriving from the computers of eligible participants, are assigned by the algorithm. These random assignments are made by an aspect of the system's programming that considers in this assignment-function, the entire universe—the Sweepstakes' pool—of computers on which this Sweepstakes application, by virtue of an appropriate user-agreement, resides.

In a particularly preferred embodiment of the invention, the random selection of the Sweepstakes' eligible participants is affected as described below. Each registered user, not opting out of participation in the online Sweepstakes, is assigned a numeric or alphanumeric identifier. A list consisting of all such identifiers constitutes the Sweepstakes' pool. A random-function generator is then used to select, from this list, the eligible participants.

Again, should an incoming signal from an eligible participant be randomly assigned to a computer within this universe, or pool, which computer has also been randomly selected as eligible for participation in the Sweepstakes of this invention, both participants, he who sought another eligible participant, and her to whose randomly selected destination-computer the program has assigned the above mentioned signal, are winners.

Also, in a preferred embodiment of this invention, the Sweepstakes' programming has certain parameters that serve to establish limits that bear on the choices made by certain functions of the program. These limits bear on matters such as how many eligible participants are randomly selected for Sweepstakes play at a given time. As an example of these cited parameters, a low number of participants and a high number of participants are established. From between this minimum and maximum number of participants is chosen the actual number of participants designated as eligible for each specific Sweepstakes contest.

Also, in a further preferred embodiment of this invention, these parameters are themselves adjusted: automatically, that is, on the basis of specific timetables, or randomly, or, as desired by an administrator.

Further as to the programming of the present system and method, in another preferred embodiment of this invention, different times of the day are, in different nations and time zones, and perhaps especially the hours from midnight to 7 AM, selected as appropriate times for prizes, if awarded, to be of greater value than at other times. Other aspects of the programming at these times of the day include increased lengths of time for the individual participant's eligibility, as well as increased numbers of such eligible participants. Also, an increased number of occurrences of the Sweepstakes of this invention are held at these times. In a particularly preferred embodiment of this invention, one Sweepstakes is held each hour during this period of time.

Another consideration in a preferred embodiment of this invention is that of a participant's device's would-be eligibility occurring during a time when their device or computer is not open to the appropriate internet site on which the Sweepstakes' appears. That is, they have been chosen as potentially eligible by the random-selection function of the server, but have failed the aspect of eligibility that requires their computer to also be open to the above-said site. This computer user will therefore not be eligible to participate in the Sweepstakes. When the device or computer is thereafter opened to said site, he is notified of his missed opportunity.

In another aspect of this invention, an eligible participant's time-limited session, fixed as to duration by the program, begins to expend upon the first depression of the return key, or upon the inception of another designated means, after the program has signaled, by means of the app's icon and or information screens, that the computer user may begin participation in the Sweepstakes.

In another aspect of this invention, the application has additional ways, other than that already mentioned, of signaling to the user of the device on which the Sweepstakes appears that he has been selected for participation in the Sweepstakes. That is, some sites, being open on the computer's view screen, in addition to the site on which the Sweepstakes is hosted, may prevent the application's icon, etc., from being seen. Some additional electronic means, perhaps visual, tactile, or sonic in nature, are utilized to alert the computer's user of his eligibility for participation.

In a yet further aspect of this invention, there are means to attempt to contact the computer user when he is not successfully made aware of his eligibility for participation in the Sweepstakes, as a result of his inattention to, or his absence from, his site-appropriately open computer and its Sweepstakes' icon. These means include the program's attempting to make contact with the computer user by ways said user has chosen. The technologies thus involved, though not limited to these cited, include telephony and radio transmission. Visual means, including texting, or tactile means, or sonic means, or other means as well, are utilized in attempting to contact the site member now eligible for Sweepstakes participation.

As mentioned, the present system and method has the means to save all of the information appearing on a device's screen at such time as the present invention becomes active and begins to display information relative to the Sweepstakes. In a preferred embodiment of this invention, this information will include advertising accompanying the Sweepstakes.

It should also be again noted that in a preferred embodiment of this invention, the participation in this invention is free to all its end-users. By “end-users” is meant the participants, who when randomly selected, seek to win the Sweepstakes. It is not the inventor's intention that the invention be charged for or sold to those who will participate as contestants in the Sweepstakes.

It has previously been suggested in this setting-out of a preferred embodiment that the Sweepstakes program, the algorithm, will reside on a server. In a further preferred embodiment of this invention, this server may or may not be a computer. It should be additionally noted that this algorithm can also reside directly on the internet, or on another similarly functioning electronic network. The Sweepstakes may reside on a website of its own, or it may reside on a social-networking site or other type of site.

The present invention also envisions participation by individuals accessing the Sweepstakes by any of various means, including all types of desktop computers, laptops, electronic pads and tablets, smart phones, game consoles, email devices, or internet-connected televisions. The invention may also exist as a mobile app. That is, it may be available on any of a user's wireless computers, especially a smart phone.

In one preferred embodiment, the invention disclosed herein is applicable to any social networking site that is attempting to fend off a rival such site. The social networking site that hosts the Sweepstakes can expect its membership numbers to increase as members seek to be subscribers to the social-networking site featuring this application. And these members will devote greater amounts of time to the site whereon this invention's Sweepstakes, at irregular and previously unannounced times, will appear.

It will be evident to those skilled in the art that the invention is not limited to the details of the foregoing illustrated embodiment and that the present invention may be embodied in other specific forms without departing from the spirit or essential attributes thereof. The present embodiment is therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed is:

1. A computer-implemented method for holding an online Sweepstakes the method comprising:
(a) using a server to determine the online Sweepstakes' pool, said pool consisting of all registered devices—which users thereof have not chosen to opt out of Sweepstakes participation—connected to the server;
(b) using a server to randomly determine a number of eligible devices for participation in the Sweepstakes;
(c) sending notification of eligibility for participation in the online Sweepstakes to the devices selected as eligible, these devices always totaling two or more;
(d) receiving a signal by the server from at least one eligible device indicating participation of said device in the online Sweepstakes;
(e) assigning of the received signal by the server, randomly, to another registered device from the number of devices in the Sweepstakes' pool;
(f) determining by the server if said eligible device's signal has been assigned to a second device also eligible to participate in the online Sweepstakes; and
(g) notifying the two eligible devices of their winning of the online Sweepstakes if the said second device is in fact also one of the devices randomly selected as eligible to participate in the online Sweepstakes.

2. The computer-implemented method of claim 1, wherein the determination by the server of the registered devices eligible to participate in the online Sweepstakes consists of random selection from all those registered devices that are open to an internet-borne site on which the Sweepstakes appears.

3. The computer-implemented method of claim 2, wherein means for notification of the eligible devices are selected from visual, tactile, and sonic means for notification.

4. The computer-implemented method of claim 3, wherein certain electronic signals, including certain keystroke entries, sent by users of the eligible participating devices are received by the server.

5. The computer-implemented method of claim 4, wherein signals, sent from the eligible participating devices to the server, are randomly assigned to other registered devices within the Sweepstakes' pool.

6. The computer-implemented method of claim 5, wherein the server, upon determining that a signal from an eligible device has been assigned to a device that has also been selected as eligible, notifies both these devices that they are winners of the Sweepstakes.

7. The computer-implemented method of claim 6, wherein means for notification of the devices are selected from visual, tactile, and sonic means of notification.

8. The computer-implemented method of claim 1, wherein the eligible devices are selected from the group of electronic devices consisting of desktop computers, laptop computers, tablet computers, smart phones, game consoles, email devices and internet-connected televisions.

9. The computer-implemented method of claim 1, wherein the two eligible devices selected for participation in the Sweepstakes have the same users.

10. The computer-implemented method of claim 1, wherein the two eligible devices selected for participation in the Sweepstakes have different users.

11. The computer-implemented method of claim 1, wherein the Sweepstakes ends after at least two eligible devices have been selected as winners.

12. The computer-implemented method of claim 1, wherein the Sweepstakes ends after more than two eligible devices have been selected as winners.

13. A system for computer-implemented Sweepstakes comprising:
(a) means for registering users' electronic devices, such devices constituting the Sweepstakes' pool;
(b) means for random selection of eligible electronic devices from the Sweepstakes' pool of registered users for participation in the Sweepstakes;
(c) means for sending electronic notification to the selected eligible electronic devices regarding their selection for participation in the Sweepstakes;
(d) means for receiving electronic signals from among these selected eligible electronic devices that indicate participation by these devices in the Sweepstakes;
(e) means for assigning each electronic signal received from these selected eligible electronic devices, which signal indicates participation by these devices in the Sweepstakes, to any one other randomly selected registered device from the Sweepstakes' pool;
(f) means for determination whether the assignment of a said signal, from an eligible registered device, has been made to a further registered device that has also been selected at this time as eligible for participation in the Sweepstakes;
(g) means for sending electronic notification to each device indicating its status relative to winning or failing to win the Sweepstakes.

14. The system of claim 13, wherein the means for random selection of eligible electronic devices, from the Sweepstakes' pool of registered users for participation in the Sweepstakes, comprise means for random-function generation technology.

15. The system of claim 13, wherein means for sending electronic notification to the selected eligible electronic devices are selected from visual, tactile, and sonic means of notification.

16. The system of claim 13, wherein certain electronic signals, including certain keystroke entries, sent by users of the eligible participating devices are received by the server.

17. The system of claim 13, wherein the means for assigning electronic signals received from eligible devices to other electronic devices comprise means for random-function generation technology.

18. The system of claim 13, wherein the means for sending notification to each device indicating their winning of the Sweepstakes are selected from visual, tactile, and sonic means of notification.

19. The system of claim 13, wherein the number of eligible electronic devices is at least two.

20. The system of claim 13, wherein the Sweepstakes ends after more than two eligible devices have been selected as winners.
